(19) United States
(12) Patent Application Publication
(10) Pub. No.: US 2012/0188042 A1
(43) Pub. Date: Jul. 26, 2012

(54) IMPLANTABLE MEDICAL DEVICE ELECTRICAL LEAD BODY

(76) Inventors: Timothy J. Claude, Coon Rapids, MN (US); Lois Claude, Coon Rapids, MN (US); Cherik T. Bulkes, Sussex, WI (US); Mary Kay Norby, Menomonee Falls, WI (US); Stephen T. Denker, Mequon, WI (US); Leonard J. Schultz, Holland, PA (US)

(21) Appl. No.: 13/435,931

(22) Filed: Mar. 30, 2012

Related U.S. Application Data
(63) Continuation-in-part of application No. 13/199,097, filed on Aug. 19, 2011.
(60) Provisional application No. 61/401,867, filed on Aug. 20, 2010.
(60) Provisional application No. 61/469,167, filed on Mar. 30, 2011.

(51) Int. Cl. H01F 27/02

(52) U.S. Cl. 336/90

(57) ABSTRACT

An electrical lead body for an implantable electronic medical device has multiple layers of insulating material encapsulating a conductor that is wound in a spiral manner along the length of the lead. The layered structure provides resistance to fracture from mechanical stresses. A manufacturing process for producing this electrical lead is described.

### CROSS-REFERENCE TO RELATED APPLICATIONS

This application is a continuation-in-part of U.S. patent application Ser. No. 13/199,097 filed on Aug. 19, 2011, and claims benefit of U.S. provisional patent application No. 61/401,867 filed on Aug. 20, 2010 and U.S. provisional patent application No. 61/469,167 filed on Mar. 30, 2011, the disclosures in which are incorporated herein by reference as if set forth in their entirety herein.

### STATEMENT REGARDING FEDERALLY SPONSORED RESEARCH OR DEVELOPMENT

Not Applicable.

### BACKGROUND OF THE INVENTION

1. Field of the Invention

The present invention relates to the structure and manufacturing process for fracture resistant, implantable electrical lead bodies for use in conjunction with implantable electronic medical devices, such as cardiac pacemakers and defibrillators, that monitor and/or stimulate a tissue of an animal for therapeutic purposes.

2. Description of the Related Art

Numerous medical conditions, such as cardiac and neurological dysfunctions, are treated by implanted electronic devices which provide monitoring and/or electrical stimulation to the affected tissues of an animal. These devices are of various types and constructions, and typically attach to the animal tissue via implanted leads. These leads may be partially or entirely intra-vascular.

Failures in the bodies of such leads may result in compromise of some or all of the functional intent of the implanted electronic device. Lead body failure modes include partial or complete insulation break, insulation perforation, partial or complete conductor coil fracture, EMI pickup by the lead body, and lead body maturation or dislodgement. For Implanted Cardiac Defibrillators (ICDs), lead body failures may manifest as over sensing, under sensing, loss of capture or non-capture, loss of output, Pacemaker Mediated Tachycardia (PMT). See Chakri Yarlagadda, MD, FACC, FASNC, FSCAI, Director of Non-Invasive Cardiology, St Joseph Health Center; Invasive Cardiologist, Ohio Heart Institute: “Pacemaker Malfunction”, Feb. 18, 2009, eMedicine from WebMD, (http://emedicine.medscape.com/article/156583-overview).

The above described lead body failures often result from mechanical stresses introduced by surgical sutures, post-surgery flexure, or lead body conductor coil mechanical resonances. The coiled helixes of the lead body conductors form a natural spring with very little damping, and can easily resonate in response to mechanical inputs from body motion. Left unchecked, such resonance will eventually result in mechanical abrasion and weakening of the surrounding lead body insulation, as well as lead body conductor coil breakage due to local metal fatigue. The above lead body failures can also be promoted by pinching of the lead body structure from suturing or pinching between skeletal structures, such as the upper ribs and clavicle. A closely wound conductor helix can be kinked by such, thus predisposing the electrical conductor to fracture.

With the definition of a Lead Defect being that which requires surgery to correct a fracture or sensing flaw, recent studies have shown that approximately 15% of ICD patients experience a lead defect within five years of implantation, that 40% of ICD patients experience a lead defect within eight years of implantation, and that the annual failure rate levels off at 20%/year beyond ten years. See Thomas Kleemann, MD: Herzzentrum Ludwigshafen, Germany, “Increasing Rates of ICD Lead Failure Noted During Long Term Follow-Up”, Heartwise, Apr. 30, 2007, (http://www.theheart.org/article/787831.do), repeated in Medscape May 4, 2007.

### Consequences of Lead Body Failure:

Lead body fractures in conjunction with ICDs may result in misinterpretation of conductor fracture induced noise as fibrillation, leading to subsequent inappropriate shocks to the patient. These shocks are often repetitive due to the structural problem in the lead body and can be traumatic to the patient. Most importantly, shocks due to lead body fractures are no longer synchronized to the patient's intrinsic heart beat in the normal fashion, and have therefore been known to induce ventricular fibrillation. In such cases, because the lead body is damaged, adequate energy for defibrillation may not be delivered and result in death to the patient. Lead body fractures in the case of pacemakers can cause over sensing and/or failure to capture which can result in the patient fainting.

Potential complications during lead-change surgery include vascular injury, venous thrombosis, cardiac tapenade, hemothorax, pneumothorax, perforation of heart, avulsion of right ventricle, bleeding, and infection. See Chakri Yarlagadda, supra.

Considering: a) the potential for inappropriate shocks to the patient; b) the severity of potential lead-replacement surgical complications; c) the existence of a few million ICD and pacemaker patients worldwide with hundreds of thousands of new implants being added yearly, and d) the potential for lead failure rates noted above, there is therefore a need for implanted medical leads to attain improved robustness and resistance to fracture from mechanical stresses. An alternative method for design and manufacturing of a lead body with improved performance is therefore needed.

The present invention pertains to a geometry and manufacturing process to create an implantable medical lead using a reflow process employing heat shrinkable tubing along the entire length of the lead. That medical lead comprises a polymer sandwich of varying polymer hardnesses surrounding the lead coils. Bottomley in U.S. Published Patent Application No. 2008/0243218 employs PET (poly(ethylene terephthalate) for various purposes including overmold insulation, spiral wrap insulation, lead-end terminations, and as spot heat shrink to aid in manufacturing steps. But Bottomley teaches neither using a sandwich of polymers of different hardnesses which are reflowed into a sandwich around the lead coils, nor the reflow technique of the present invention wherein heat shrinkable tubing is employed along the entire length of the lead and then heated to effect a uniform polymer reflow. Bottomley instead teaches a drawdown reflow process using a heated die. The Kampa, et al. U.S. Pat. No. 7,112,298 describes the use of a polymer to form the diameter of a catheter lumen, and manufacturing the balance of the catheter in layers around this interior coating. Drawdown through heated dies is mentioned as a method of forming outer layers of the catheter. Neither the full-length heat shrinkable tubing process of the present invention, nor implantable lead manufacture, is mentioned. The Snow U.S. Published Patent Application No. 2001/0010247 teaches manufacturing of reinforced thin walled cannula with a relatively large lumen, in which a coated elongate member is wound in a helical manner around a mandrel. Heat shrinkable tubing compresses the elongate prior to heating to aid in the elongate member sealing its own interlocking edges. Other layers may be added on top of the elongate, with heat used to fuse these subsequent layers together. No mention is made of implantable lead manufacture via a sandwich of polymers of different hardnesses which are reflowed into a sandwich around lead coils.

### SUMMARY OF THE INVENTION

The present invention defines an alternative design and associated manufacturing process which together produce implantable medical lead bodies with improved robustness and resistance to fracture from mechanical stresses, resulting in a decrease in the presently experienced lead failure rates detailed above. They are intended as an alternative to prior design and manufacturing techniques, attempting to overcome recognized limitations of the prior art.

In the present implantable medical lead body a lead body conductor coil or coils is embedded in a sandwich of a polymer (such as for example polytetrafluoroethylene, silicone, or polyurethane) which has degrees of hardness in such a way as to allow for lead body flexure in both the radial and longitudinal directions. That polymer sandwich provides a supporting structure for the lead body conductor coils.

Another aspect of the current invention is attainment of intimate contact between the polymer sandwich material and the lead body conductor coils by means of a reflow process.

A further aspect is providing the ability to vary the lead body flexibility and handling characteristics by selecting different combinations of polymer hardness and thickness.

Yet another aspect of the invention is use of the softest polymer layer directly over the lead body conductor coils to encapsulate them and to provide flexibility as well as mechanical damping.

Another aspect of the current invention is elimination of mechanical resonances in the conductor coils by the polymer sandwich.

Still another aspect is a lead body conductor coil pattern that leaves some space (approximately one-fourth to two times the conductor width) between adjacent turns of the coil conductors (or between adjacent filars of the electrical conductor) to allow movement without coil-to-coil interference.

A further aspect of the current invention is incorporation of a lumen core at the center of the lead body.

Another aspect of the current invention is production of an implantable medical lead body with improved robustness and resistance to fracture from the suture and flexing introduced mechanical stresses commonly experienced by implantable leads.

### BRIEF DESCRIPTION OF THE DRAWINGS

FIG. 1 is a longitudinal cross section of a non-stick coated mandrel with a first set of blockers attached.

FIG. 2 is a longitudinal cross section of the lead body shown in FIG. 1 with a first insulating layer applied following reflowing of the first insulating layer.

FIG. 3 is a longitudinal cross section of the lead body shown in FIG. 2 following the winding of a conductive coil layer and an attached second set of blockers.

FIG. 4 is a longitudinal cross section of the lead body shown in FIG. 3 following the application of a second insulating layer prior to reflowing the second insulating layer.

FIG. 5 is a longitudinal cross section of the lead body shown in FIG. 4 following reflowing the second insulating layer.

FIG. 6 is a longitudinal cross section of the lead body shown in FIG. 5 following the application of a third insulating layer prior to reflowing the third insulating layer.

FIG. 7 is a longitudinal cross section of the lead body following reflowing of the third insulating layer.

FIG. 8 is a longitudinal cross section of the lead body following removal of the mandrel.

FIG. 9 is a longitudinal cross section of the completed lead body.

FIG. 9A is a lateral cross section of the lead body taken through the lines 9A-9A of FIG. 9.

FIG. 10 is a flow chart illustrating the steps of the method of the invention.

FIGS. 11A and 11B are side and end views, respectively, of only an electrical conductor coil that has been wound in the conventional manner;

FIGS. 12A and 12B are side and end views, respectively, of only an electrical conductor coil wound according to the present invention;

FIG. 13 is a side view of a dual filar coil assembly that alternatively may be used in the electrical lead in place of the coil in FIG. 12; and

FIG. 14 is a side view of a double dual filar coil assembly that alternatively may be used in the electrical lead in place of the coil in FIG. 12.

### DETAILED DESCRIPTION OF THE INVENTION

The lead body configuration and associated manufacturing process encompassed by the current invention together provide improved robustness and resistance to fracture from the suture, flexing, and vibration introduced mechanical stresses commonly experienced by implantable leads.

The current invention spans the areas of geometric configuration design, material selection, manufacturing techniques, and manufacturing steps.

### DEFINITIONS

“Filar” means the number of separate conductive strands wound onto the lead body.

“Reflow” means applying sufficient pressure and temperature to a polymeric material to cause it to change configuration.

“Teflon®” is used here in its generic sense and includes PTFE, ETFE, FEP and other non-stick coatings.

The manufacturing process creates the layers of the electrical lead body 100 in a step-by-step fashion from the inside-out as follows.

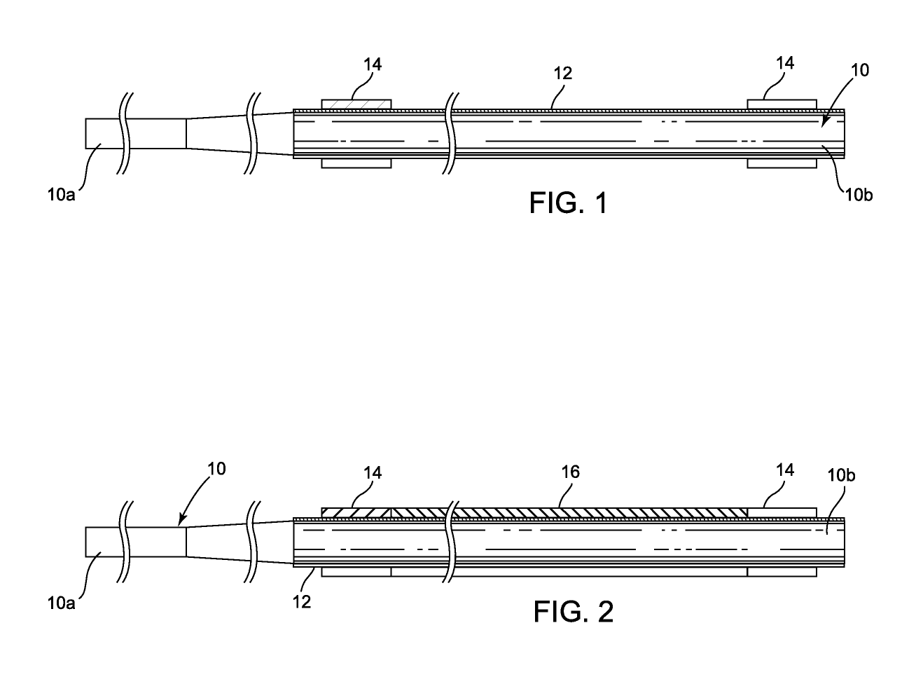

As best shown in FIG. 1, the method begins at step 50 with the procurement of a mandrel 10, which can be stainless steel, Teflon® or other materials able to withstand the temperatures and pressures of the method of the present invention. The mandrel 10 defines an outer dimension which will eventually correspond to the inner dimension of the lumen 30 of the eventually completed electrical lead body 100. The mandrel 10 also defines a tapered end 10a and a non-tapered end 10b. The tapered end 10a serves to facilitate easier loading of tubular first 16, second 22 and third 26 insulating layers onto the mandrel 10 as well as the heat shrink tubing (not shown) used to reflow the first 16, second 22 and third 26 insulating layers that form the substrate of the lead body. In this embodiment, the mandrel 10 is coated with a layer of non-stick coating 12 such as Teflon® or another compound characterized by chemical inertness as well as possessing significant non-stick characteristics. In one embodiment, the mandrel comprises a stainless steel wire with a sheet of Teflon® applied to it. A first set of blockers 14 at step 52 is placed over the Teflon® coated 12 mandrel 10 and serves to assist in preventing the migration of subsequently applied layers during the manufacturing process. In one embodiment the first set of blockers 14 comprise tubing of heat shrink material that is heated following application causing the blockers 14 to decrease in size and closely conform to the outer contours of the mandrel 10. The first set of blockers 14 can be made of PET (polyethylene terephthalate) heat shrink material, however, it is noted that other materials possessing similar characteristics would also work, thus the invention is not considered to be so limited.

FIG. 2 shows the lead body following the application of a first insulating layer 16 between the first set of blockers 14 at step 54 which serves to create a uniform outer diameter as well as acting to add structural strength to the eventually completed lead body 100. In one embodiment, the first insulating layer is made of a 55D polyurethane material such as Pellethane, made by Dow Chemical, which is relatively rigid and adds strength and integrity to the eventually completed lead body 100. In other embodiments, the first insulating layer 16 can also be made of other urethane, silicone or other polymeric materials able to withstand the temperature and pressure requirements necessary to reflow and provide the necessary biocompatibility. The first insulating layer 16 can be made by an extrusion process.

Then, the first insulating layer 16 is applied to the mandrel 10 as a tube which is slid over the tapered end 10a of mandrel 10 followed at step 56 by sliding a first length of heat shrink tubing (not shown) also over the tapered end 10a, over the not yet reflowed first insulating layer 16. The first length of heat shrink tubing material (not shown) is then exposed at step 58 to heat for a period of time sufficient to cause the first heat shrink material (not shown) to decrease diametrically in size and to reflow the first insulating layer 16. In one embodiment, suitable heat shrink materials include FEP (fluorinated ethylene polypropylene), however, it is noted that other materials possessing similar characteristics would also work, thus the invention is not considered to be so limited. Due to variables such as the pitch of the spiral wound electrical conductor 20 and the thickness of the first, second and third insulating layers 16, 22, 26 it is difficult to characterize the heat treatment necessary to cause the first, second and third insulating layers 16, 22, 26 to reflow. In one embodiment, a vertical reflow system is used (not shown), which is well known to those skilled in the art. A vertical reflow system comprises a cylindrical chamber which is provided with a heat source through which the lead body is sequentially passed. It has been found that the first, second and third insulating layer 16, 22, 26 successfully reflow at a temperature of 450 degrees C., plus or minus 25 degrees C. when passed through a vertical reflow system at a speed of 0.1 to 0.3 centimeters per second. Following reflowing of the first insulating layer 16 the first length of heat shrink tubing (not shown) is removed and discarded at step 60.

The process of gradual heating, with compression applied by the heat-shrinkable-tubing, results in a relatively uniform thickness layer of polymer being deposited on the mandrel, forming first insulating layer 16.

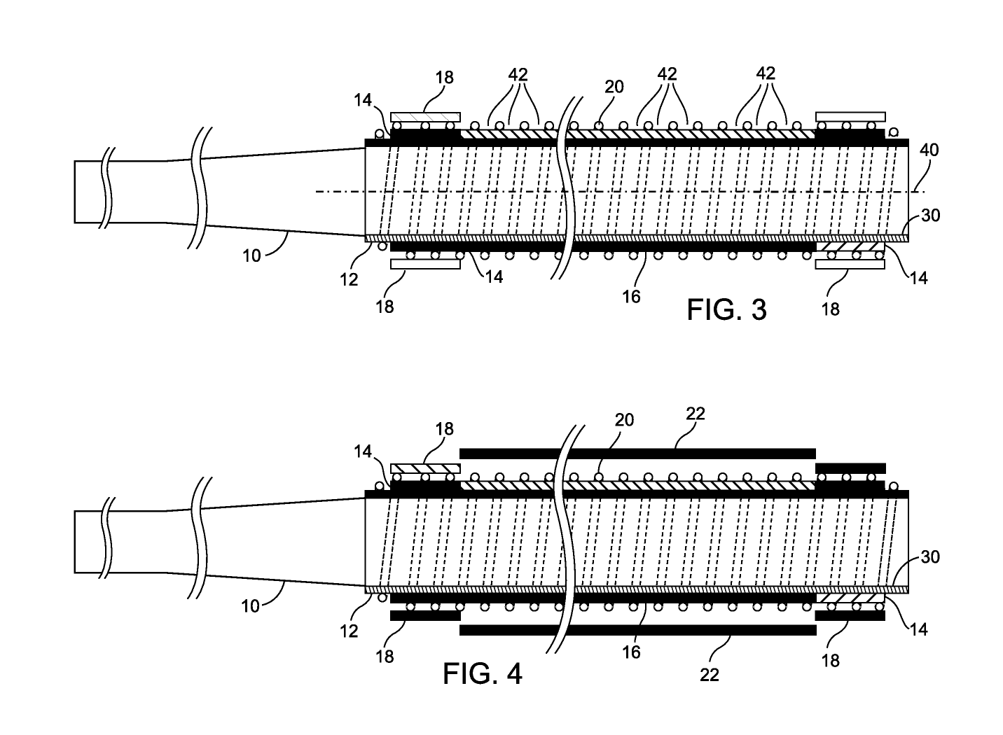

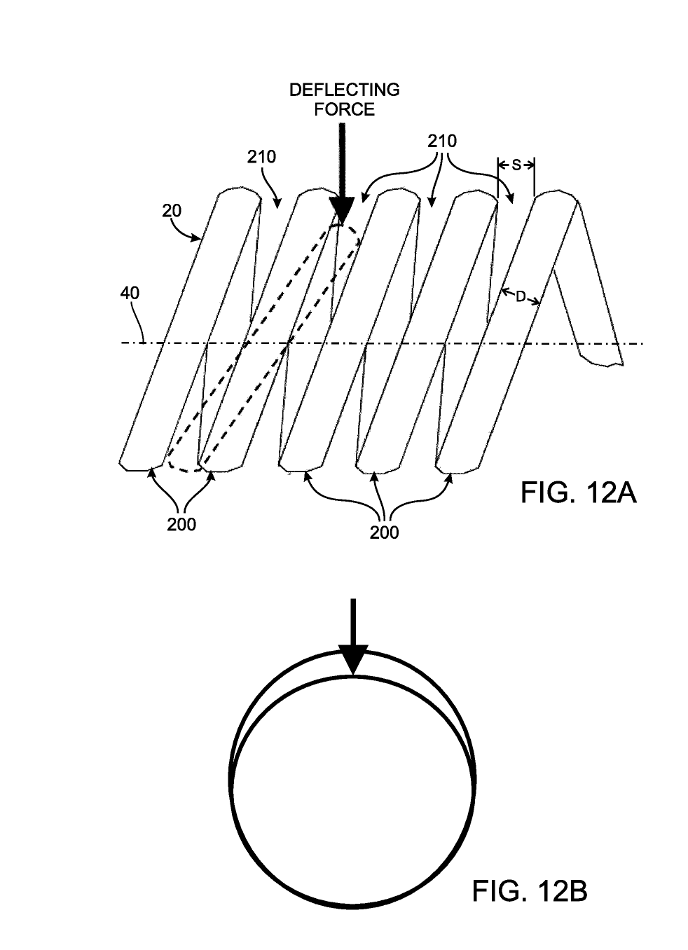

FIG. 3 illustrates step 62 and the placement of a conductive coil layer 15 formed by winding the electrical conductor 20 in a longitudinal spiral around the outer surface of the first insulating layer 16. With additional reference to FIG. 12, the coils or turns 200 of the electrical conductor 20 are wound helically along the length of the electrical lead. That winding process creates a space 42 between adjacent turns on at least one side of the longitudinal axis 40 of the electrical lead body 100. The distance of each space 42 is approximately one-fourth to two times the diameter of the electrical conductor 20. The spaces 42 allow the conductor to deflect when stressed radially and also allows for an individual coil turns to rotate sideways slightly.

The electrical conductor 20 in one embodiment is MP35N drawn fused tubing sold under the name DFI® but could also be any non-ferromagnetic material having sufficient conductivity to deliver electrical energy through the lead body 100. The MP35N drawn fused tubing is an insulated conductor which could be insulated by such bio-compatible materials such as Teflon®, polyimide, urethanes or other materials. The conductive coil layer 15 may be initially secured in place using a variety of methods (e.g., crimping, swaging, heat shrink, others) (not shown). It is understood that the winding pattern for the conductive coil layer 15 shown herein is for purposes of illustration only and therefore does not limit the scope of the invention. As an example, the winding pattern as illustrated is monofilar, however, the invention is also compatible with multifilar applications. It is also understood that while a single conductive coil layer is shown in the drawings, this is for purposes of illustration only and therefore additional embodiments utilizing multiple conductive coil layers are also compatible with the method of this invention and therefore within its scope.

In one embodiment the second set of blockers 18 comprises a heat shrink material, where at step 64 the heat shrink material is placed over the coil between the second set of blockers 18 and serves to prevent the migration of the subsequent (i.e., second 22 and third 26) insulating layers. In one embodiment, suitable heat shrink materials include PET (polyethylene terephthalate) heat shrink material, however, it is noted that other materials possessing similar characteristics would also work, thus the invention is not considered to be so limited. Placement of the second set of blockers 18 is followed by the application of heat to cause the heat shrink material to shrink in size.

FIG. 4 shows the application at step 66 of a second insulating layer 22 over the uncompleted lead body. In one embodiment the second insulating layer 22 comprises a polyurethane material which is a softer material than 55D polyurethane and functions as a dampener or shock absorber. Thus the degree of hardness of the second insulating layer 22 is less than the degree of hardness of the first insulating layer 16. Additionally, the second insulating layer 22 serves to precisely bind the conductive coil layer 15 to the first insulating layer 16 thus ensuring the accuracy of the intended diameter and pitch of the conductive coil layer 15 which maintains the desired electrical performance characteristics. The second insulating layer 22 is applied to the lead body as a tube which is slid over the tapered end 10a of the mandrel 10 and uncompleted lead body.

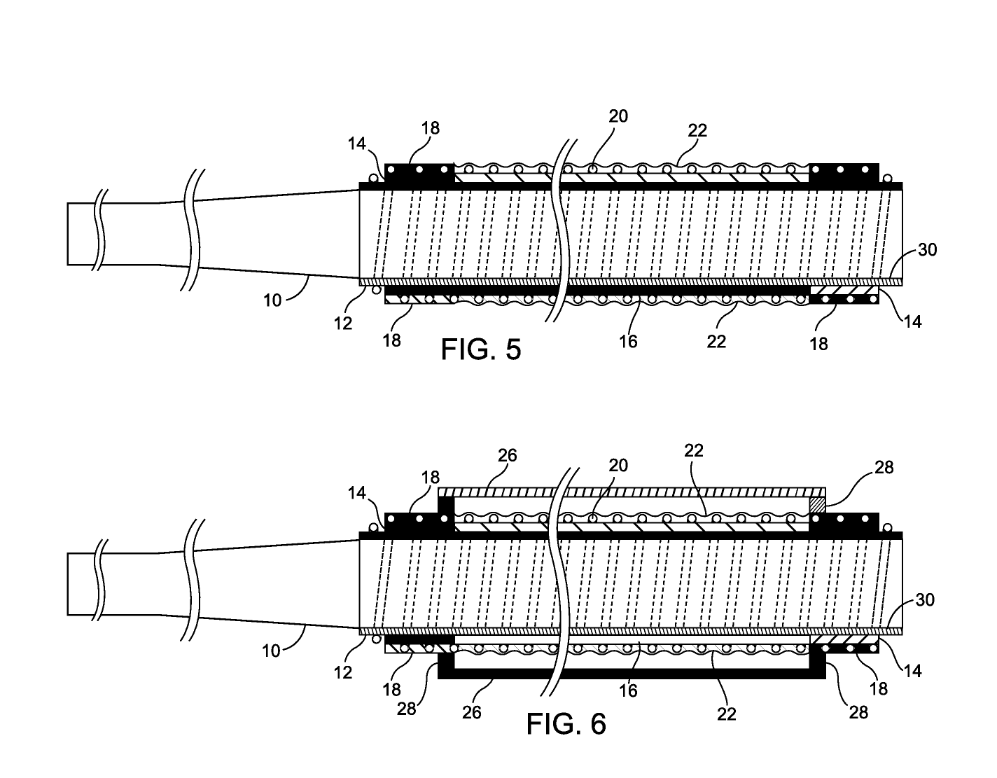

FIG. 5 shows the lead body following reflowing of the second insulating layer 22. Reflowing is accomplished at step 68 by sliding a second length of heat shrink tubing (not shown) over the second insulating layer 22 which at step 70 is then exposed to a sufficient amount of heat for a period of time sufficient to cause the heat shrink tubing (not shown) to decrease in size and to reflow the second insulating layer 22. In one embodiment, suitable heat shrink materials include an FEP (fluorinated ethylene polypropylene) heat shrink material, however, it is noted that other materials possessing similar characteristics would also work, thus the invention is not considered to be so limited. The pressure exerted on the second insulating layer 22 by the decreasing size of the heat shrink tubing (not shown), in combination with the exposure to heat energy causes the material of the second insulating layer 22 to reflow, results in the second insulating layer 22 being uniformly molded around the uncompleted lead body. Thus the second insulating layer material flows between the turns of the electrical conductor 20 and into contact with the first insulating layer 16. This results in the electrical conductor 20 being permanently secured in place. Reflowing of the second insulating layer 22 also results in the second insulating layer 22 fusing with the first insulating layer 16, while still maintaining separate layers. Following reflowing of the second insulating layer 22, the heat tubing (not shown) is removed and discarded at step 72.

As shown in FIG. 6, a third insulating layer 26 is applied at step 76 as a tube that is slid over the lead body. In one embodiment the third insulating layer 26 comprises a 55D urethane material which is a relatively firm material, which primarily serves to add strength and an additional degree of integrity to the completed lead body 100. Also shown in FIG. 6 is the addition of a third set of blockers 28 which can be heat shrink material placed towards the outer ends (unnumbered) of the uncompleted lead body. It should be noted that in some embodiments, the third set of blockers 28 may not be used, depending on the thicknesses of the insulating layers. Placement of the third set of blockers 28 is followed by the application of heat to cause the heat shrink material to reduce in size, thereby securing the third set of blockers at the desired position on the lead body. When used, the third set of blockers 28 functions to prevent the reflowed third insulating layer 26 from flowing beyond the third set of blockers 28. The third set of blockers 28 can be made of PET (polyethylene terephthalate) heat shrink material, however, it is noted that other materials possessing similar characteristics would also work, thus the invention is not considered to be so limited.

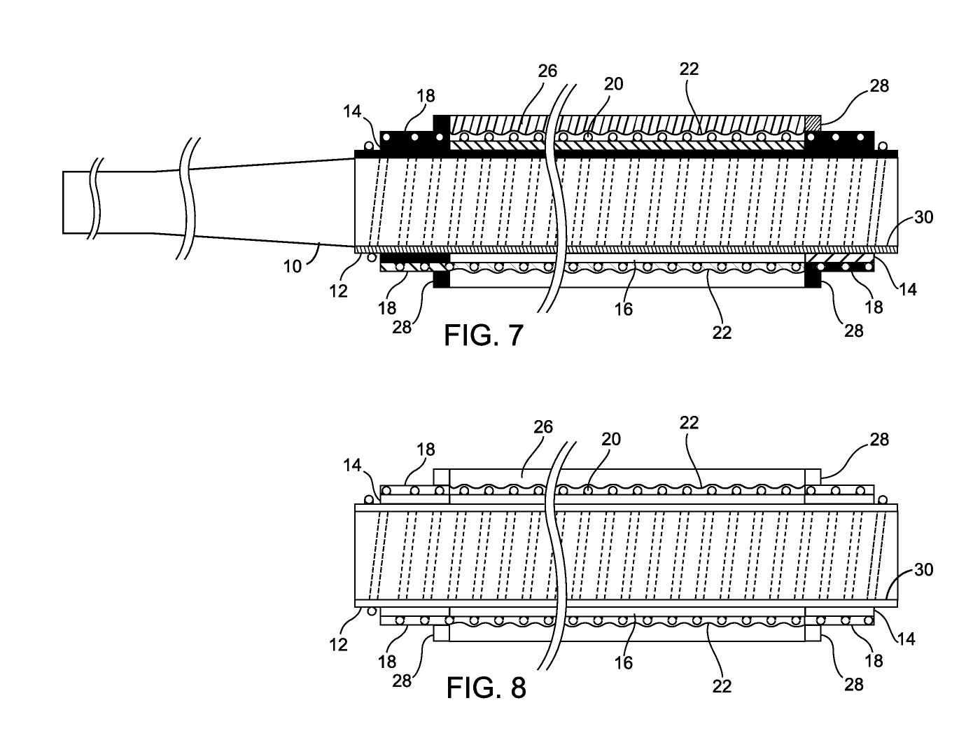

FIG. 7 shows reflowing the third insulating layer 26 which is accomplished at step 78 by sliding a third length of heat shrink tubing (not shown) over the third insulating layer 26 which at step 80 is then exposed to a sufficient amount of heat for a period of time sufficient to cause the heat shrink tubing (not shown) to decrease in size and reflow the third insulating layer 26. In one embodiment, suitable heat shrink materials include an FEP (fluorinated ethylene polypropylene) heat shrink material, however, it is noted that other materials possessing similar characteristics would also work, thus the invention is not considered to be so limited. Following reflowing of the third insulating layer 26 the heat shrink tubing (not shown) is removed and discarded at step 82. The pressure exerted on the third insulating layer 26 by the decreasing size of the heat tubing material, in combination with the exposure to heat energy causes the third insulating layer material to reflow, resulting in the third insulating layer 26 being uniformly molded around the lead body. Reflowing of the third insulating layer 26 also results in the third insulating layer 26 fusing with the second insulating layer 22, while still maintaining separate layers.

FIG. 8 shows the lead body 100 following removal of the mandrel 10. It is noted that a lumen 30 is formed where the mandrel 10 had previously been in place. Removal of the mandrel 10 at step 84 first requires loosening of the first, second and third sets of blockers 14, 18, 28, which frees the mandrel 10 from the lead body 100, allowing the mandrel 10 at step 86 to be withdrawn from the lead body without damaging the lead body. The function of the first, second and third sets of blockers 14, 18, 28 is to ensure that the first, second and third reflowed insulating layers 16, 22, 26 end at the same point. In one embodiment they would be perfectly aligned, but perfect alignment is not absolutely required. Following removal of the lead body 100 from the mandrel 10, the lead body is trimmed at step 88 to expose the conductive coil layer 15, allowing later attached electrodes and connectors to be in electrical communication with various devices.

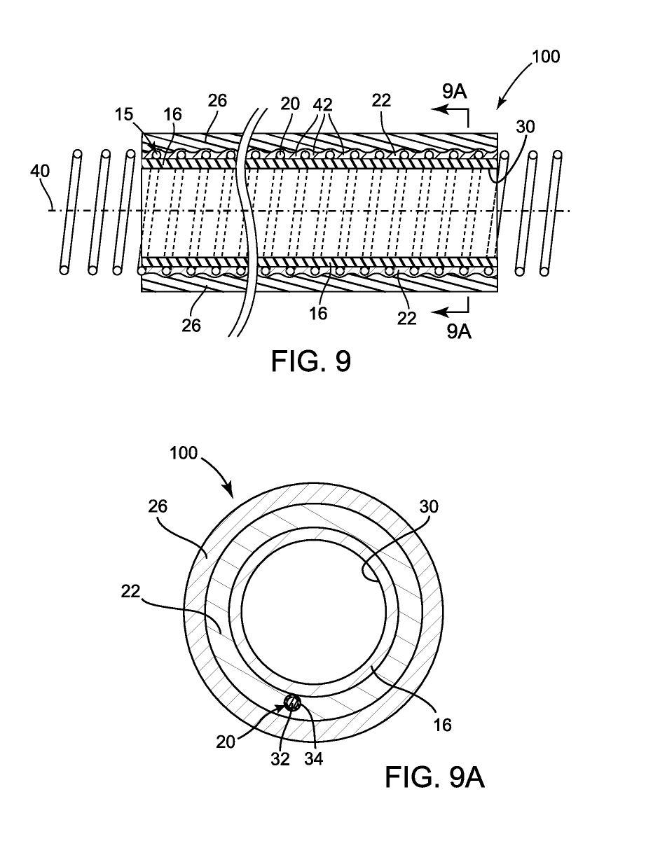

FIG. 9A is a lateral cross section taken through the lines 9A-9A of the completed lead body 100 (FIG. 9) and shows the various layers built up during the manufacturing process and the lumen 30.

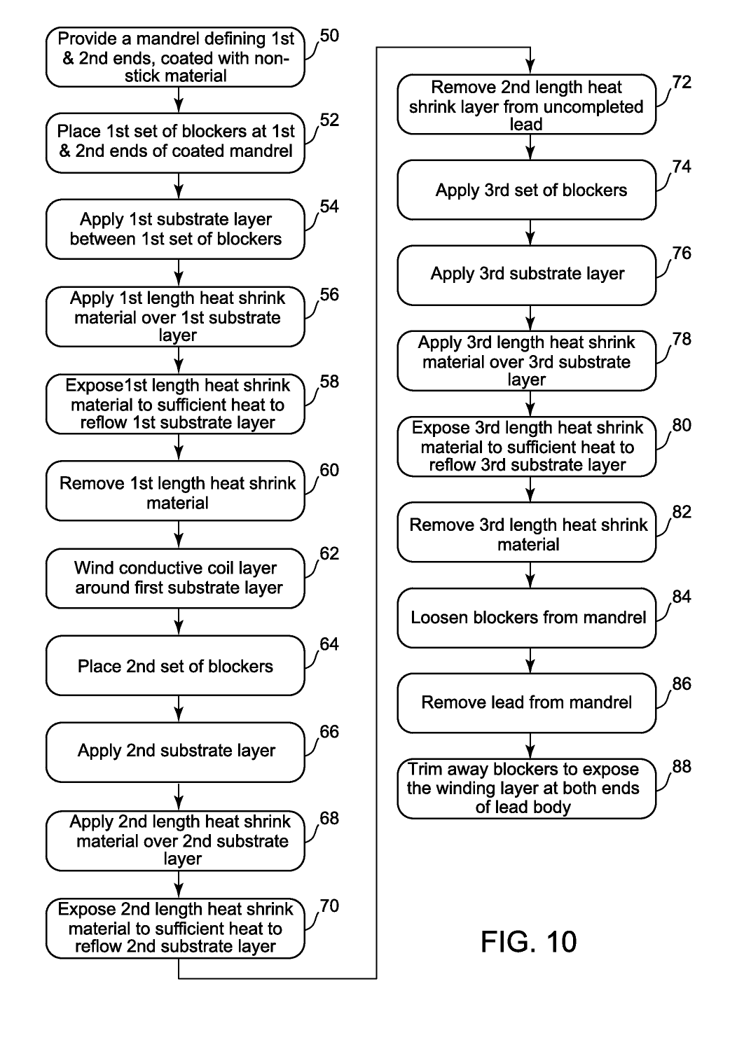

FIG. 10 is a flow chart illustrating the various steps of the manufacturing process, including reflowing of the first, second and third insulating layers 16, 22, 26.

### Geometric Configuration

FIGS. 9 and 9A illustrate the geometry of the present electrical lead body 100. A lumen 30 is at the center of the body, surrounded by a first insulating layer 16 of a polymer, for example. Thus, the first insulating layer provides a cylindrical lumen core of the electrical lead body. Next is the conductive coil layer 15 comprising an electrical conductor 20 spirally wound in a coil extending longitudinally along the length of the lead electrical lead body 100. The electrical conductor 20 has a metal wire 32 enclosed in a covering 34 of an electrically insulating material. The electrical conductor 20 in the coil layer 15 is wound from wire commonly used for implanted lead applications (stainless steel or a nickel-cobalt base alloy such as MP35, as examples). Surrounding the coil layer 15 is a second insulating layer 22 of a material (such as a polymer selected from silicone, polyurethane, or polytetrafluoroethylene, for example) that provides the necessary biocompatibility for the electrical lead body 100.

All the insulating layers by be made of the same general type of material or different materials, however, in either case the layers have a particular relationship in respect of their degrees of hardness. Specifically, the second insulating layer 22 is softer than the first and third insulating layers 16 and 26. That is, the second insulating layer 22 has a lower degree of hardness that both the first and third insulating layers 16 and 26. The first and third insulating layers 16 and 26 may have the same or different degrees of hardness. The relative hardness and thickness of the insulating layers 16, 22, and 26 may be varied to affect the desired lead body flexibility and handling characteristics, provided that the second insulating layer 22 is softer than the first and third insulating layers 16 and 26. The polymers of layers 16, 22, and 26 provide inherent biocompatibility with the animal into which the electrical lead body 100 will be implanted.

A cushioning, vibration damping sandwich is formed by surrounding the conductive coil layer 15 by polymer layers 16, 22 and 26. This sandwich structure of multiple coaxial insulating layers reduces mechanical resonances within the coiled electrical conductor 20, thereby minimizing such resonances as a potential cause of conductor fatigue which could eventually result in lead body failure. The relative softness of second insulating layer 22 relative to the first and third insulating layers 16 and 26 is essential to achieve this vibration dampening.

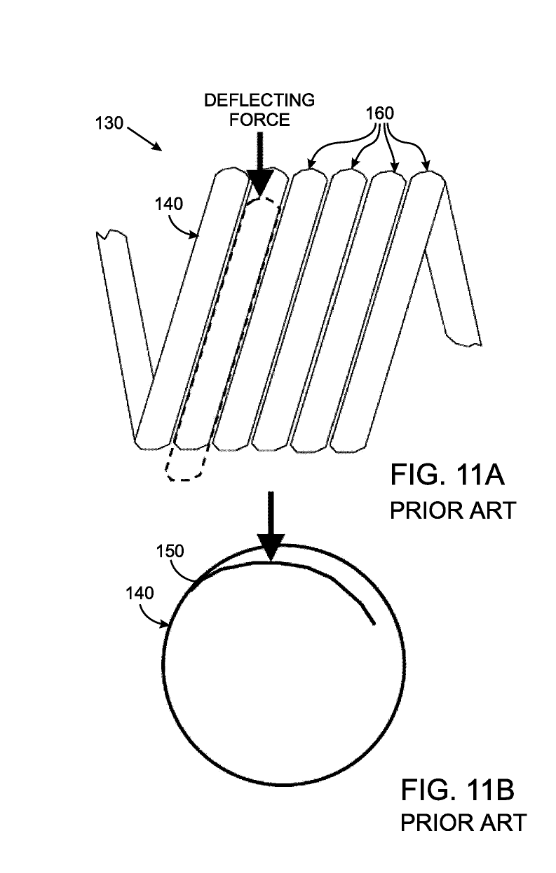

With reference to FIGS. 9 and 12A, the coils or turns 200 of the electrical conductor 20 are wound helically in a spiral around the first insulating layer 16 along the electrical lead. That winding process creates a space 210 between adjacent turns 200 on at least one side of the longitudinal axis 40 of the electrical lead body 100. The distance “S” of each space 210 is approximately one-fourth to two times the diameter “D” of the electrical conductor 20. The spaces 210 allow the electrical conductor to deflect when stressed radially. In conjunction with the relatively softer polymer second insulating layer 22, these spaces 210 also allow for the individual coil turns to rotate sideways slightly, thereby reducing the potential for kinking cause by suturing or crushing. Such a kink 150, as occurred in previous leads 130 (see FIG. 11B), cause a weakness in the electrical conductor 140 at that point, potentially leading to conductor material fatigue and eventually breakage over time in the presence of repeated mechanical stress. The turns 160 of the electrical conductor 140 in such previous leads were closely spaced, typically adjacent turns touched each other.

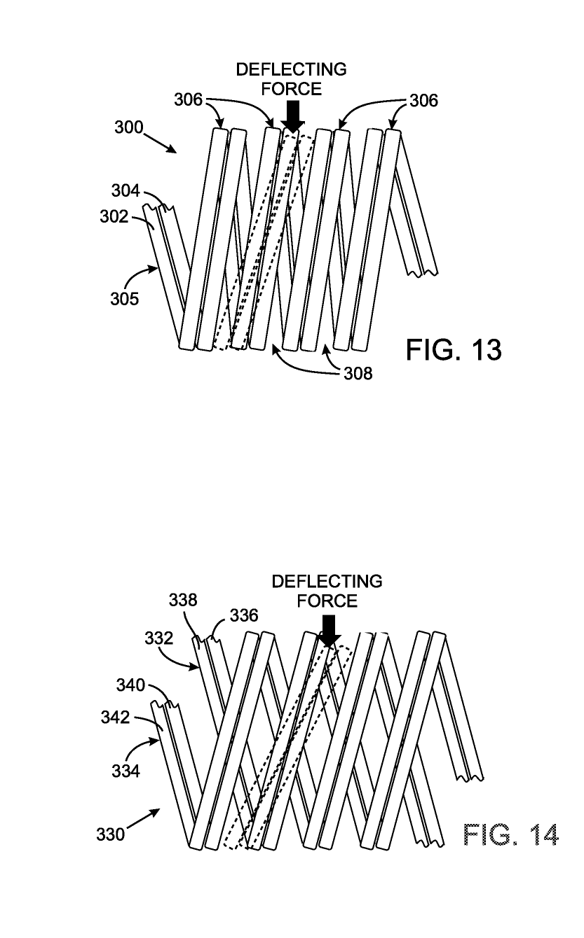

The new electrical lead body 100 depicted in FIGS. 9 and 12 has a single filar electrical conductor structure. Alternatively, a multiple filar conductor structure may be used. With reference to FIG. 13, the electrical conductor 300 has two filars 302 and 304 in close proximity to each other, preferably abutting, tangentially along their lengths and wound in a longitudinal spiral lengthwise along the electrical lead body, thereby forming a filar pair 305. Each filar 302 and 304 has a conductive wire encased in a outer layer of insulation. As with the single filar, electrical conductor 20 described previously herein, each turn 306 of the filar pair 305 has a space 308 there between. Each space 308 is approximately one-fourth to two times the diameter of the electrical conductor of each filar. Alternatively, more the two filars be grouped together like filars 302 and 304 and that group wound as a spaced apart spiral along the length of the electrical lead body.

FIG. 14 illustrates the structure of another multiple filar electrical conductor 330 that as two groups of filars wound in spaced apart interleaved helixes. This electrical conductor 330 has first and second filar groups 332 and 334. The first filar group 332 has first and second filars 336 and 338 in close proximity to each other, preferably abutting, tangentially along their lengths, and the second filar group 334 has third and fourth filars 340 and 342 also in close proximity to each other, preferably abutting, tangentially along their lengths. Each filar 336, 338, 340, and 342 has a conductive wire encased in an outer layer of insulation. The two filar groups 332 and 334 are wound in a longitudinal spiral along the length of the electrical lead body. The first and second filar groups 332 and 334 are continuously spaced apart by a distance approximately one-fourth to two times the diameter of the electrical conductor in each filar. Alternatively, there may be more than two filar groups wound as a spaced apart spiral along the length of the electrical lead body, and each group may have more than two filars.

The foregoing description was primarily directed to a certain embodiments of the industrial vehicle. Although some attention was given to various alternatives, it is anticipated that one skilled in the art will likely realize additional alternatives that are now apparent from the disclosure of these embodiments. Accordingly, the scope of the coverage should be determined from the following claims and not limited by the above disclosure.

We claim:

1. An electrical lead body for an implantable electronic medical device, said electrical lead body comprising:
a first layer of a first electrically insulating material forming an elongated core;
an electrical conductor wound in a longitudinal spiral around the first layer, wherein turns of the longitudinal spiral are spaced apart;
a second layer of a second electrically insulating material around and abutting the first layer, wherein the electrical conductor is embedded in the second layer; and
a third layer of a third electrically insulating material extending around and contiguous with the second layer.

2. The electrical lead body as recited in claim 1 wherein the second electrically insulating material is softer than both the first electrically insulating material and the third electrically insulating material.

3. The electrical lead body as recited in claim 2 wherein the first electrically insulating material and the third electrically insulating material have identical degrees of hardness.

4. The electrical lead body as recited in claim 2 wherein the first electrically insulating material and the third electrically insulating material have different degrees of hardness.

5. The electrical lead body as recited in claim 1 wherein at least one of the first, second and third electrically insulating materials is a polymer.

6. The electrical lead body as recited in claim 1 wherein each of the first, second and third electrically insulating materials is a polymer.

7. The electrical lead body as recited in claim 1 wherein the first, second and third electrically insulating materials are selected from a group consisting of silicone, polyurethane, and polytetrafluoroethylene.

8. The electrical lead body as recited in claim 1 wherein turns of the longitudinal spiral are spaced apart by approximately one-fourth to two times a diameter of the electrical conductor.

9. The electrical lead body as recited in claim 1 wherein the first layer has a longitudinal lumen.

10. The electrical lead body as recited in claim 1 wherein hardness of the first, second, and third insulating materials and spacing apart the turns of the electrical conductor enables the electrical lead body to flex longitudinally and radially.

11. The electrical lead body as recited in claim 1 wherein the electrical conductor comprises a single filar.

12. The electrical lead body as recited in claim 1 wherein the electrical conductor comprises a plurality of filars wound helically along the elongated core and spaced apart from each other.

13. The electrical lead body as recited in claim 1 wherein the electrical conductor comprises a plurality of filar groups, each having a plurality of filars wound helically along the elongated core, wherein the plurality of filar groups are spaced apart from each other.

14. An electrical lead body for an implantable electronic medical device, said electrical lead body comprising:
a first layer of a first electrically insulating material forming an elongated core;
an electrical conductor wound in a longitudinal spiral around the elongated core, wherein turns of the longitudinal spiral are spaced apart by approximately one-fourth to two times a diameter of the electrical conductor;
a second layer of a second electrically insulating material extending around the electrical conductor and in between the turns; and
a third layer of a third electrically insulating material extending around the second layer.

15. The electrical lead body as recited in claim 14 wherein the second electrically insulating material is softer than both the first electrically insulating material and the third electrically insulating material.

16. The electrical lead body as recited in claim 15 wherein the first electrically insulating material and the third electrically insulating material have identical degrees of hardness.

17. The electrical lead body as recited in claim 15 wherein the first electrically insulating material and the third electrically insulating material have different degrees of hardness.

18. The electrical lead body as recited in claim 14 wherein at least one of the first, second and third electrically insulating materials is a polymer.

19. The electrical lead body as recited in claim 14 wherein each of the first, second and third electrically insulating materials is a polymer.

20. The electrical lead body as recited in claim 14 wherein the first, second and third electrically insulating materials are selected from the group consisting of silicone, polyurethane, and polytetrafluoroethylene.

21. The electrical lead body as recited in claim 14 wherein the first layer has a longitudinal lumen.

22. The electrical lead body as recited in claim 14 wherein the electrical conductor is embedded in the first layer.
